(19) United States
(12) Patent Application Publication
(10) Pub. No.: US 2008/0042492 A1
(43) Pub. Date: Feb. 21, 2008

(54) Electric power distribution and backup power supply system

(76) Inventors: Patrick Thomas Gleason, Los Angeles, CA (US); Mitchell A. Gonzalez, Las Vegas, NV (US); Thomas Howard Murphy, Fort. Wayne, IN (US)

Correspondence Address: Patrick T. Gleason, 1421 E. Sunset Rd #11, Las Vegas, NV, 89119, US

(21) Appl. No.: 11/893,261

(22) Filed: Aug. 15, 2007

Related U.S. Application Data
(60) Provisional application No. 60/838,409, filed on Aug. 17, 2006.

(51) Int. Cl. H02J 9/06

(52) U.S. Cl. 307/66

(57) ABSTRACT

This invention is a power distribution system and backup power supply that includes a distinctive arrangement of electrical charging and power distribution circuits and batteries in a compact housing that mounts on utility light and electric poles. The device provides backup power using AC power line feed, and comprises of AC/DC converters for providing regulated rectified DC current for charging batteries, power detection and monitoring circuits to determine battery state information including current, voltage and temperature, and regulated AC power or DC power to an electronic device (i.e. wireless router). The device provides electricity to an electronic piece of equipment in event of normal power cycling or an unforeseen power outage. The device includes a housing that provides protection from environmental elements such as solar, wind and temperature cycles, and is easily attachable via a unique clamping arrangement to a variety of street light and electric pole designs.

### CROSS REFERENCE TO RELATED APPLICATIONS

This application is claiming the benefit of Provisional Application 60/838,409 filed on Aug. 17, 2006 under 35U.S.C. 119(e).

### STATEMENT REGARDING FEDERALLY SPONSORED RESEARCH OR DEVELOPMENT

None

### NAME OF PARTIES TO A JOINT RESEARCH AGREEMENT

None

### REFERENCE TO SEQUENTIAL LISTING

None

### BACKGROUND OF THE INVENTION

1. Field of the Invention

The present invention generally relates to electrical power distribution and power supplies and specifically to a backup power supply system and distribution that includes an AC power source connected thereto such that the system can continue to provide electricity to an electronic device in the event of a disruption of the AC power source or an external power outage. More specifically, it relates to a utility pole mounted, electrical power supply and distribution device for telecommunications equipment.

2. Description

a power supply is crucial in maintaining proper operation of any electronic device especially in situation where data integrity or continuous operation is essential. This is especially critical where the device is part of a wireless operational network.

conventionally, where devices for wireless connectivity require continuous operation they are provided with a backup power supply such as a solar panel array with batteries, or a standard bank of batteries to prevent any connectivity or data loss, or avoid malfunction during operation due to shutoff of power due to temporary power outage.

In the distribution of wireless nodes on electric power and light poles, the availability of 24 hour AC power is not always available, but usually AC power is available during the night hours, so a power distribution and backup power supply is utilized for the day time hours to maintain proper operation of the wireless device.

Electrical power available at public utility intersections is notoriously unstable; as power fluctuates it can cause transients that impact the operation of the wireless devices installed on the utility light and power poles.

in the conventional technique, as described above, the physical footprint size of the power distribution and backup power supply is larger then the available space in the immediate area specifically the utility pole base and cross arm.

in the conventional technique, as describe above; the method of installation is clumsy and awkward and could cause a safety issue to the installers.

### SUMMARY OF THE INVENTION

the object of the present invention is to provide a power distribution and backup power supply system with a 120 VAC power source and DC voltage power source. The invention has the following advantages. It can continue providing AC power to a connected wireless electronic device in the event of power outage or switching off of the 120/240 VAC power source in the daylight hours. It is a cost effective device.

the power voltage protection circuit monitors the battery voltage and automatically shuts off the charging circuit based on prescribed over and under voltage conditions, thus protecting the battery units from damage

the power monitor controller includes any power failure conditions and telemetry information on temperature, battery voltage status and current draw.

the device optionally includes an Ethernet interface so the data can be accessed remotely via a wireless or landline Ethernet network for remote monitoring of the state of the invention using a simple World Wide Web based Internet browser.

the invention's housing provides a simple and effective profile for mounting the device that minimizes the wind and static load on the utility or light pole.

the invention's housing is weather proof enclosure and design to resist water penetration, cracking from heat or cold and damage from external objects.

the invention's housing includes a simple and effective clamping apparatus that securely mounts the housing to the utility or light pole but allows the user to easily replace the unit without removing the installation bracket

the invention's clamping device includes one or more safety straps for securing the housing to the standard light pole or utility power pole during and after the installation process.

the invention includes as option the ability to connect to the AC power available on standard light pole's photocontrol, shorting cap, or nonshorting cap three-pole locking type receptacle.

the invention has the ability to energize the electronics only when the appropriate connectors are installed.

### BRIEF DESCRIPTION OF THE DRAWINGS

FIG. 1 is a functional block diagram of the device

FIG. 2A and FIG. 2B is a cut away view of the right side of the invention

FIG. 3 is a view of the bottom plate of the invention with input/output/data connector ports

FIG. 4 is a rear view of the mounting clamp attached to the back of the housing

FIG. 5 is a top view of the housing and housing mounting plate attached to the utility pole clamp bracket

FIG. 6 is a top view of the mounting plate and utility pole clamp with safety strap

### DETAIL DESCRIPTION OF THE INVENTION

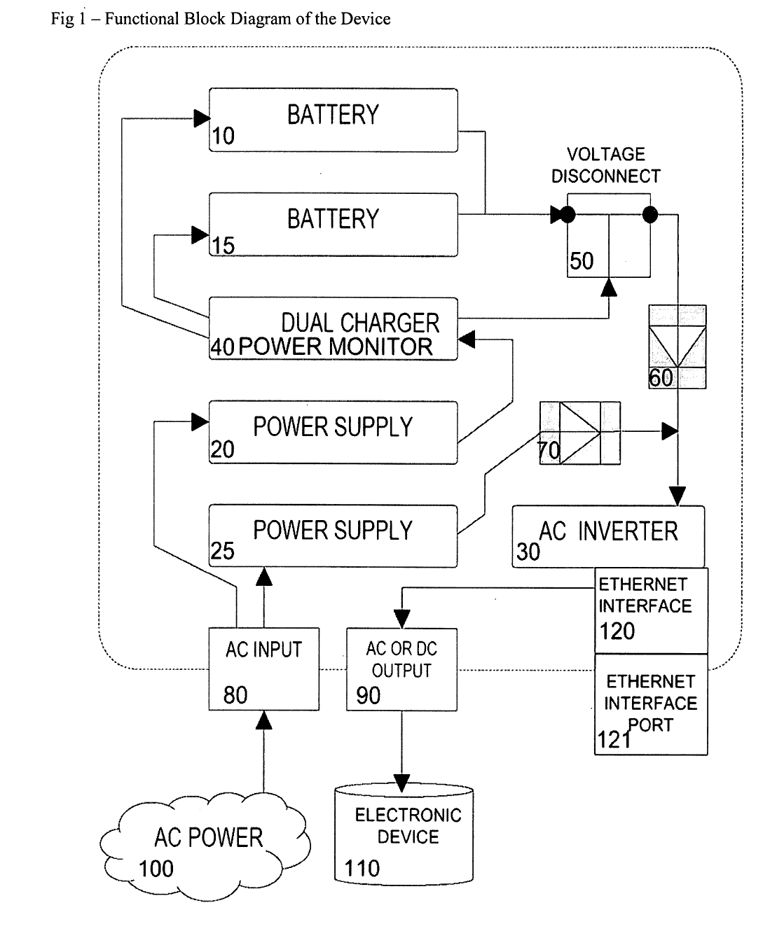

FIG. 1 shows a block diagram indicative of a general configuration of the device demonstrating various functional sections. The device comprises of a one or more Alternating Current and Direct Current power supply 20 and 25 electrically connected to an external 120/240 VAC power source 100 through an input port 80. The Power Supplies are electrically connected to a Dual Charger Circuit 40 and through a diode 70 to the DC to AC inverter circuit 30. The direct connect through the DC to AC inverter circuit 30 is to maintain continuous power to the electronic device 110 such as telecommunications equipment used in a wireless network deployment while AC power source 100 is available. The Dual Charger Circuit 40 provides rectified DC current to charge one or more batteries 10 and 15 wired in parallel. The batteries provide DC power through a voltage disconnect circuit 50 and a diode 60 to the DC to AC inverter 30. The DC to AC inverter 30 through a power distribution circuit 90 provides AC power to the electronic device 110.

In the embodiment, the backup power supply Dual Charger and power monitoring Circuit 40 maintains control of the ratio of power output to the batteries to maintain a proper balance of voltage charge to the batteries. The duration of the charging period is set by algorithms appropriate to the battery chemistry and charge condition.

In the embodiment, the backup power supply Dual Charger and power monitor Circuit 40 maintains a monitor of the batteries condition of current draw and voltage. A separate temperature sensor provides continuous readings. These conditions are stored via a buffer device. Separately, an Ethernet interface 120 provides the ability to access these readings remotely via the Simple Network Management Protocol (SNMP) standard interface using a standard Ethernet interface port 121 to a local area network. The Ethernet interface is accessible through a WEB based interface browser for remote configuration of the device via the local area network.

in the embodiment, the power distribution circuit provides both AC power from the DC to AC inverter 30 or external AC power source directly 100, or DC voltage 12 Volt 90 to the external electronic device (i.e. wireless router) 110.

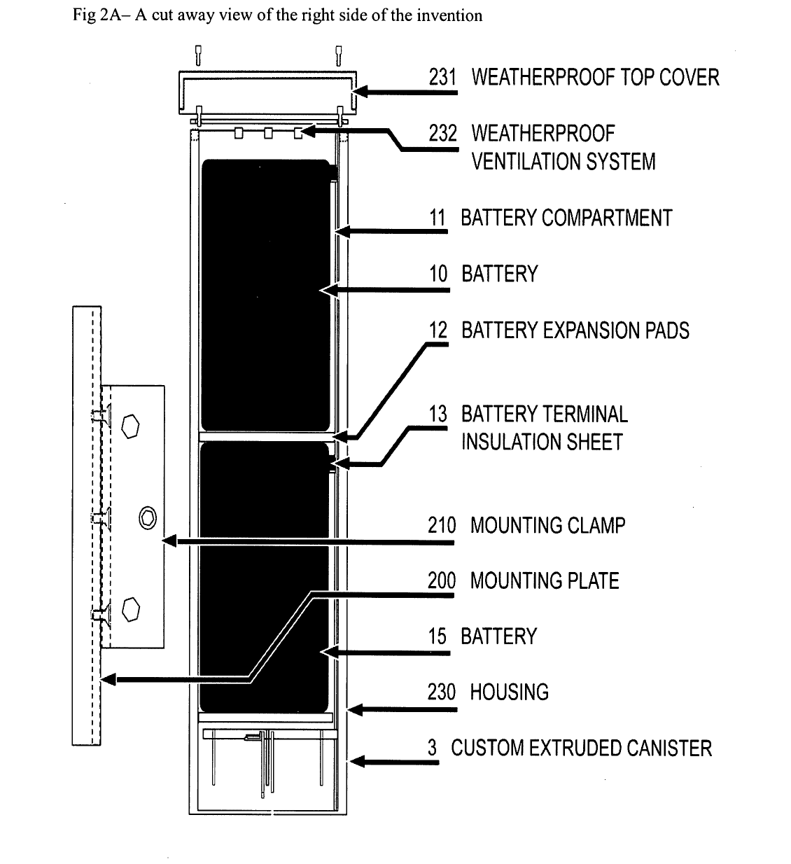

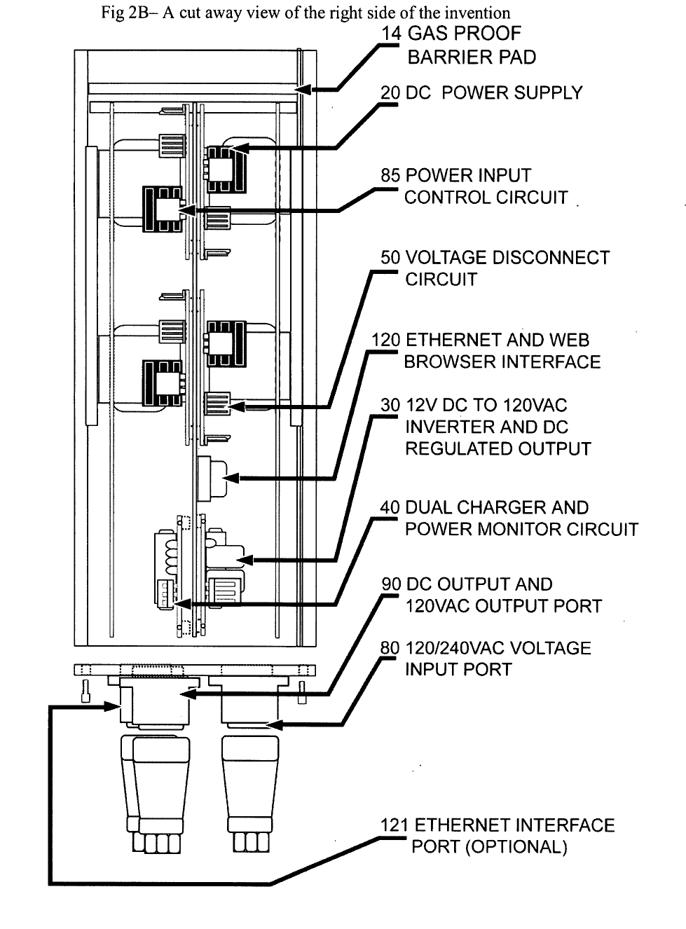

Referencing, FIG. 2A and FIG. 2B is a cut away view of the right side of the invention. The invention provides backup power supply and power distribution in a low profile, compact configuration suitable for mounting on the base of electric light poles or utility electric poles.

Referencing FIG. 2A, the device includes a mounting clamp 210 with integrated mounting plate 200 to facilitate one-handed installation. The housing 230 has an inset to accept the mounting plate 200 for ease of installation on light poles and electric utility poles.

Referencing FIG. 2A, the housing 230 consists of various items to protect the electronic package and batteries from environmental and internal elements. The housing includes a weatherproof top cover 231 and ventilation ports 232 to protect the device from rain and variances in barometric pressure and any internal gas leakage from the batteries. The housing is constructed of aluminum to protect the device from solar and other environmental elements. The housing is a cube shape to blend well with the base of a utility pole and provide minimum wind load resistance.

Referencing FIG. 2A, the device includes a battery compartment 11 which can have one or more batteries 10, and is separated from the electronic package. Each battery is protected by an expansion pad 12 to take into consideration heat expansion. Also, a terminal insulation sheet 13 is included to protect against accidental shorting of a battery. A gas proof barrier pad 14 is used to protect the electronic circuits from corrosion in case of any battery leakage. The canister is a custom extrusion 3 that can be cut to various lengths to accommodate one or more batteries depending on power requirements for a specific application.

Referencing FIG. 2B, the housing modular electronic package consisting of the various functional electronic circuit boards can be installed as a cohesive unit. It includes the DC Power Supply bank 20 where the number of power supplies is a function of the number of batteries use in the application. Also, a power input control circuit 85 that energizes the device only if the AC power input connector 80 is installed. The voltage disconnect circuit 50 that monitors that the batteries are protected from damage due to voltage variances above or below a specific threshold based on the battery chemistry used. The 12V to 120 VAC inverter 30 converts the battery input to a 120 Volt AC sine wave output for powering the load. This circuit also provides a regulated 5V or 12V DC feed to the output connector as an alternative to power the electronic equipment. An Ethernet and Web Browser interface 120 is provided to optionally provide the readings from the dual charger and power monitor circuit 40 using a Simple Management Network Protocol (SNMP) standard and the standard Terminal Control Protocol/Internet Protocol (TCP/IP) for transmitting the data over an external area network. The Dual Charger and Power Monitoring Circuit 40 provides the control of the charging of the individual batteries using an equalization scheme based on predetermined algorithms appropriate to a specific type of battery chemistry. The concept is to control the charge of the batteries at different rates based on feedback from the monitoring circuits. The monitoring circuits have sensors that indicate each battery voltage and current draw and temperature and the status of the 120 VAC input. These readings are available at the Ethernet interface port 121 for access by an Ethernet interface to a local area network.

Referencing FIG. 2B, the connectors are weatherproof snap lock type style. They consist of three types of cables. The AC Input 120/240 VAC 80 input connector that routes the 120/240 VAC input source to the device. This connector also provides a signal to the power input control circuit 85 and it energizes the device. Optionally this connector can be provided with a cable that can function with a standard roadway locking-type photocontrol shorting or nonshorting cap mating receptacle. This receptacle is the standard for directly wiring to the existing lamp fixture on the arm of a municipal street light, so that the device can be powered from the supply circuits rather then a separate AC power feed.

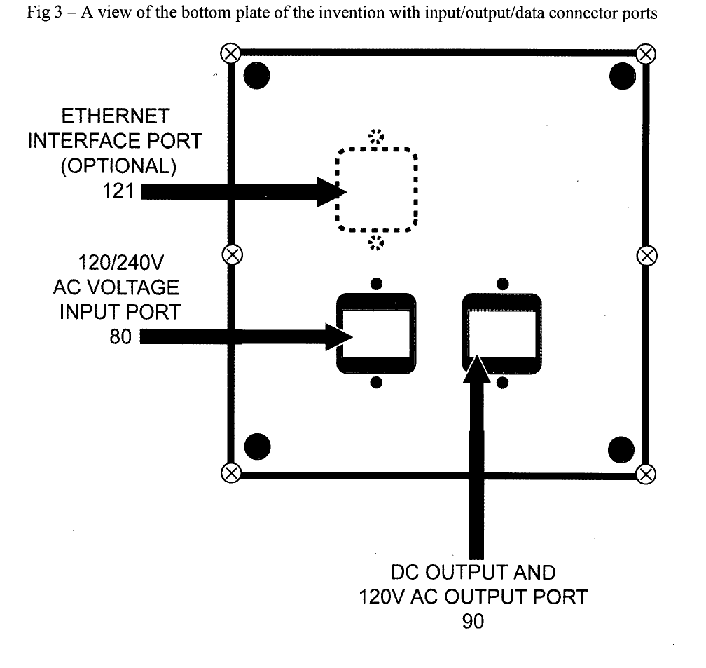

Referencing FIG. 3 is a view of the bottom plate of the device indicating the AC Voltage input port 80, the AC and DC voltage output port 90, and Ethernet interface 121 port. It provides more detail as to specifically where the connectors are mounted and their relationship to each other.

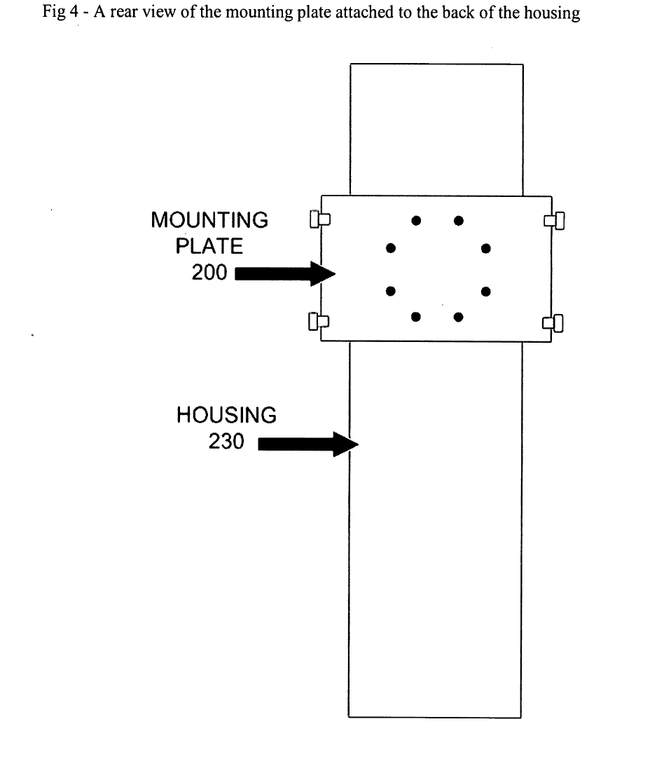

Referencing FIG. 4 is a rear view of the mounting plate 200 to the device's housing 230. This figure provides more detail as to the relationship of the mounting plate to the housing. Multiple holes are predrilled in the mounting plate so that the plate and housing can be installed at various angles with the utility clamp bracket that mounts to the utility pole. This is to ensure that the device is installed in as close to a vertical direction to the utility pole as possible.

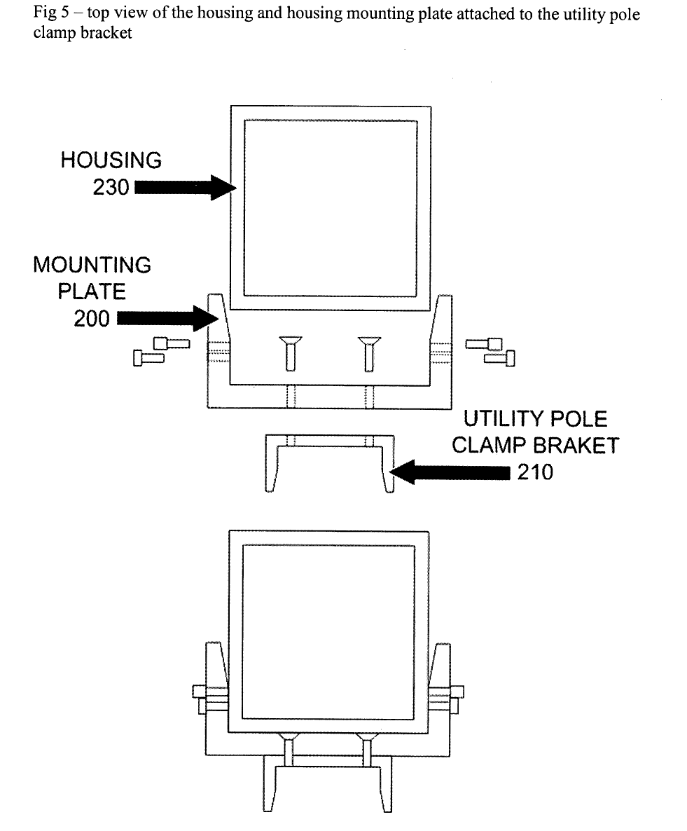

Referencing FIG. 5, FIG. 5 is a top view of the mounting plate 200 indicating how the housing 230 is cradled into the plate, and the mounting plate is fastened to the utility pole clamp bracket 210. Stainless steel screws attach the Mounting Plate to the Utility Pole Clamp Bracket. Stainless steel thumb screws in the mounting plate insert into insets in the housing. FIG. 5 also shows the Utility Pole Clamp Bracket, the Mounting Plate and Housing as an assembly.

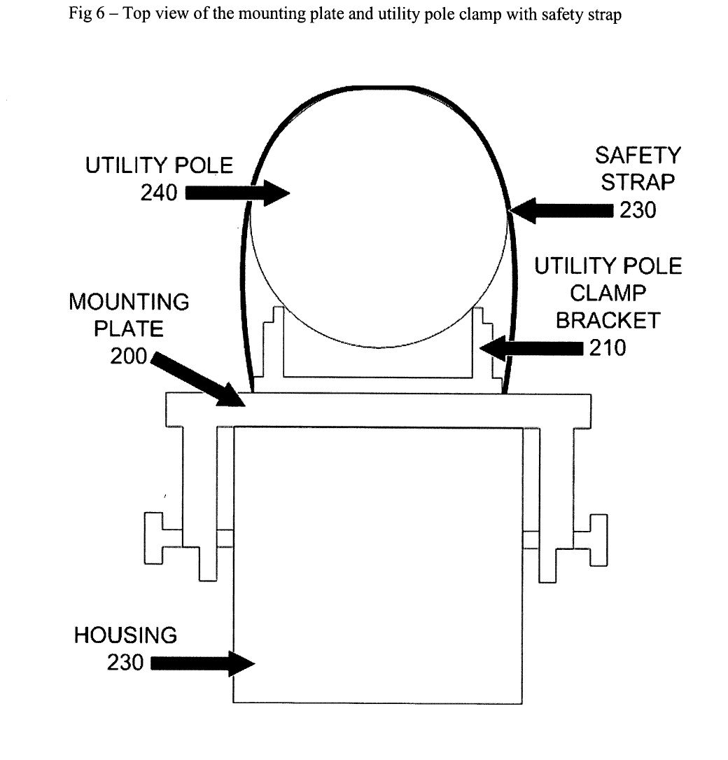

Referencing FIG. 6 is a top view of the housing 230, the mounting plate 200, the Utility Pole Clamp Bracket 210 as an assembled unit and indicating how the safety strap 230 is wound around the utility pole 240. The safety strap is a stainless steel band held by a screw down fastener. The Utility Pole Clamp Bracket has two grooves fabricated to allow two safety straps to encircle the utility pole. Also, the Utility Pole Clamp Bracket has ridges on the pole side to provide a firm grip into the wood or steel pole.

in the foregoing description, certain terms and visual depictions are used to illustrate the preferred embodiment. However, no unnecessary limitations are to be construed by the terms use or illustrations depicted, beyond what is shown in the prior art, since the terms and illustrations are exemplary only, and are not meant to limit the scope of the present invention.

while the invention herein disclosed has been described by means of specific embodiments, numerous modifications, and variations could be made thereto by those skilled in the art without departing from the scope and spirit of the inventions set forth in the claims.

1. An electric power distribution and backup power supply system comprising a main housing containing at least one AC to DC power supply for taking AC power from an outside source to provide a regulated DC to a battery charger circuit for controlling current flow to a series of twelve volt batteries; an AC power inverter for converting DC voltage from the battery charger circuit to AC power for an outside electronic device; each housing includes a plurality of receptacles including a first receptacle for receiving electrical power, a second for providing power to an electrical device, and an additional receptacle for connection to an external monitoring electronic device.

2. The electric power distribution and backup power supply system of claim 1, wherein the additional receptacle is used for an Ethernet data port.

3. The electric power distribution and backup power supply system of claim 1, further including a bypass circuit including input switching devices which routes DC current from the AC to DC power supply to said AC power inverter to continuously feed current to the electronic device while the outside AC power source is connected.

4. The electric power distribution and backup power supply system of claim 1, wherein the battery charger circuit includes means for protecting the twelve volt batteries from under or over voltage conditions.

5. The electric power distribution and backup power supply system of claim 1, wherein the first, second and additional receptacles are snap lock receptacles.

6. The electric power distribution and backup power supply system of claim 1, further including means for directly mounting said main housing to any section of a utility or electric pole.

7. The electric power distribution and backup power supply system of claim 6, wherein the means for mounting said main housing to said utility or light pole is a clamping device.

8. The electric power distribution and backup power supply system of claim 7, wherein said clamping device incorporates one or more safety straps.
